(19) United States
(12) Patent Application Publication
(10) Pub. No.: US 2010/0304175 A1
(43) Pub. Date: Dec. 2, 2010

(54) HIGH STRENGTH MULTI-LAYER BRAZING SHEET STRUCTURES WITH GOOD CONTROLLED ATMOSPHERE BRAZING (CAB) BRAZEABILITY

(75) Inventors: Raymond J. Kilmer, Lancaster, PA (US); Michael P. Danz, Lancaster, PA (US); John F. Butler, JR., Litiz, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: ALCOA INC., Pittsburgh, PA (US)

(21) Appl. No.: 12/475,183

(22) Filed: May 29, 2009

(51) Int. Cl. B23K 35/02

(52) U.S. Cl. 428/576

(57) ABSTRACT

The present invention relates to aluminum brazing sheet with high levels of Magnesium in the core layer and having good Controlled Atmosphere Brazing (CAB) brazeability and suitable for use with any commercially available brazing flux, including brazing flux with or without Cesium.

### FIELD OF THE INVENTION

The present invention relates to aluminum brazing sheet and, more particularly, the present invention relates to high strength aluminum brazing sheet with high levels of Magnesium in the core layer and having good Controlled Atmosphere Brazing (CAB) brazeability.

### BACKGROUND OF THE INVENTION

Aluminum brazing sheet is used extensively in the fabrication of heat exchangers where the light weight and high thermal conductivity of aluminum alloys provide advantages over other materials such as copper. This is particularly true for heat exchangers used in the transportation industry where weight and size are important considerations. Fabricators of these heat exchangers continue to reduce the size and weight of these units often by reducing thickness and increasing strength of the starting raw materials used to form the various components of the units. Down-gauging typically needs to be accompanied by increased post-braze strength so to not compromise the integrity of the final product. Increasing post-braze strength usually means increasing the overall amount of alloying elements (Cu, Mn, Si, Mg, etc.) in the core alloy. Magnesium (Mg) in particular is a very potent solid solution strengthening element in aluminum. Additionally, when Mg is present at high enough concentrations in combination with Silicon (Si) then it can participate in an age-hardening reaction, which can significantly increase the strength of the material.

While Mg is a tolerable and necessary element in the vacuum brazing process for aluminum, it has a very negative impact on the braze-ability of aluminum in the Controlled Atmosphere Brazing (CAB) process. The reason for the negative impact has long been recognized as due to the interference of Mg with the fluxing action of the commonly utilized CAB fluxes, as exemplified by the industry standard Nocolok® brazing flux. Consequently, the level of Mg in the core alloy of the brazing sheet is typically limited to 0.25 wt. % or lower for CAB brazing applications, and even that can result in a noticeable degradation in the brazing performance. The vacuum brazing process is an older technology and continues to be displaced by the newer CAB process. Therefore, the limitations on Mg as a strengthening element is becoming more commercially important with the current aluminum braze sheet designs and CAB process. There are CAB fluxes that are modified with Cesium that have some moderately increased tolerance for Mg, those fluxes are more expensive than standard Nocolok® and often are not acceptable for that reason. The greater use of Mg presents a clear opportunity for increasing strength with some current alloys reaching their reasonable limits for the other primary alloying elements (Mn, Si, Cu and Cr). However, the known negative impact Mg has on brazing performance is restricting that opportunity.

In addition to the known CAB brazing issues with high Mg alloys, fabrication of multi-layer composite brazing sheet alloys with high Mg layers is very challenging on a commercial level. These products are traditionally fabricated by a hot-roll bonding process. The use of high Mg layers brings with it significant problems from a bonding standpoint in the hot mill. The large difference in high temperature flow stress between Mg-bearing layers and Mg-free layers results in non-uniform metal flow and therefore difficulty in control of the thickness of the various layers through the sealing process. In addition, Mg-bearing alloys readily generate thick oxide layers at high temperatures. These oxide layers can strongly impede the bonding process between adjacent layers. The present invention resolves these fabrication problems by casting the high Mg-bearing core alloy as part of a multi-layer ingot in a multi-alloy casting process in which the high-Mg core is cast adjacent to at least one Mg-free or very low Mg-bearing interliner. That composite multi-layer ingot is then further processed in the mill via hot and cold rolling and annealing to fabricate the final product.

### SUMMARY OF THE INVENTION

The present invention is embodied in claims 1-33 and is suitable for use with brazing flux with or without the addition of Cesium, such as NOCOLOK® brazing flux.

### BRIEF DESCRIPTION OF THE DRAWINGS

FIG. 1 an envisioned high strength tubestock material (150 to 400 microns thickness);

FIG. 2a an envisioned “one side clad” high strength side-support or tank material (≧1 mm thickness);

FIG. 2b an envisioned “two side clad” high, strength side-support or header material (≧1 mm thickness);

FIG. 3 is a schematic structure of a fabricated high strength tubestock material; and

FIG. 4 are plots of exemplar braze liner and inter liner thicknesses versus core Mg content.

### DETAILED DESCRIPTION OF THE INVENTION

The present invention is a multi-layer brazing sheet partially or completely fabricated via a multi-alloy casting process by which the beneficial impact of Mg on post-braze strength can be realized in brazed heat exchangers while maintaining excellent CAB brazing performance with standard Nocolok® brazing flux. The present invention is a composite multi-layer brazing sheet in which a Mg-rich core layer is effectively isolated from the braze filler metal by interlayers that functionally act as diffusion barriers for the Mg during fabrication in the mill and during the braze cycle. The process starts by producing a multi-layer composite ingot in which the Mg-rich core layer is adjacent to or between essentially Mg-free interlayers (up to 0.05 wt. %). The composition and thickness of these interlayers is such that after processing the ingot to the wrought sheet product and subjecting it to the required forming and braze thermal cycle, that the Mg content of the liquid filler metal during the braze cycle does not exceed 0.10 wt. %, wherein one embodiment includes a Mg content below 0.05 wt. %.

In the present invention, core Mg levels of up to 3.0 wt. % are possible. One embodiment of a high Mg core comprised about 0.5 wt. % to 3.0 wt. % Mg. Another embodiment of a high Mg core comprises about 1.0 wt. % to about 3.0 wt. % Mg. Another embodiment of a high Mg core comprises about 1.1 wt. % Mg. Another embodiment of a high Mg core comprises about 1.5 wt. % to about 3.0 wt. % Mg. Yet another embodiment of a high Mg core comprises about 2.0 wt. % to about 3.0 wt. % Mg. Another embodiment of a high Mg core comprises about 2.5 wt. % to about 3.0 wt. % Mg. This is a significant departure from all previous brazing sheet composite materials and will result in significant increases in post-braze strength while maintaining excellent CAB braze-ability. When referring to any numerical range of values, such ranges are understood to include each and every number and/or fraction between the stated range minimum and maximum. For example, a range of about 0.5 to 3.0 wt. % would expressly include all intermediate values of 0.6, 0.7, 0.8, 0.9, and 1.0 wt. %, all the way up to and including 2.8, 2.9, and 3.0 wt. % Mg. The same applies to each other numerical property, relative thickness and/or elemental range set forth herein.

One embodiment of the present invention includes a substantially Magnesium (Mg)—free inter-liner (skin) on a high Mg core alloy whereby the control of the thickness of the skin material controls the Mg diffusion out of the core.

One aspect of the present invention is the ability to cast multi-alloy layer composite ingots with discrete layers of different alloy compositions as described below. One embodiment of the present invention employs the Simultaneous Multi-Alloy Composite casting technology disclosed in U.S. Pat. No. 6,705,384 by Kilmer et al. (incorporated herein by reference). Another embodiment of the present invention employs the Simultaneous Multi-Alloy Composite casting technology disclosed in U.S. Pat. No. 7,407,713 by Kilmer et al. (incorporated herein by reference). Another embodiment of the present invention employs the Unidirectional Solidification of Casting process disclosed in U.S. Pat. No. 7,264,038 by Men Chu et al. (incorporated herein by reference). Another embodiment of the present invention employs the Unidirectional Solidification of Casting process disclosed in U.S. Pat. No. 7,377,304 by Men Chu et al. (incorporated herein by reference). Another embodiment of the present invention employs the “Fusion” method for casting composite ingot disclosed in U.S. Pat. No. 7,472,740 by Anderson et al. (incorporated herein by reference). The invention is not limited to those multi-layer ingot casting processes sited. Any casting process that can produce a multi-layer ingot wherein at least one of the layer compositions is a high Mg-bearing alloy is envisioned to be embodied in this invention. By casting the various alloy layers in a controlled manner into one multi-layer ingot the significant aforementioned production issues associated with bonding on the hot mill are eliminated. The composite ingot of this present invention can be partially processed in the conventional manner (e.g., hot-roll/bonding). For example, the fabrication steps can include hot-roll bonding a multi-layer composite ingot cast via a multi-layer alloy casting process comprising a high-Mg core layer bounded by one or two essentially Mg-free interliner layers to one or two 4000-series braze layers in a hot roll bonding process. Alternatively that multi-layer composite ingot can be bonded to one 4000-series braze liner and a different layer (for instance a 3000-series or 7000-series alloy on the opposing side of the composite in a hot-roll bonding process. The AA4000 series braze cladding alloy can comprise up to about 2.5 wt. % Zn. Another embodiment of the AA4000 series braze cladding alloy can comprise less than 0.1 wt. % Mg. Those multi-layer composites would then be fabricated to finished product of desired gauge and temper in the traditional manner.

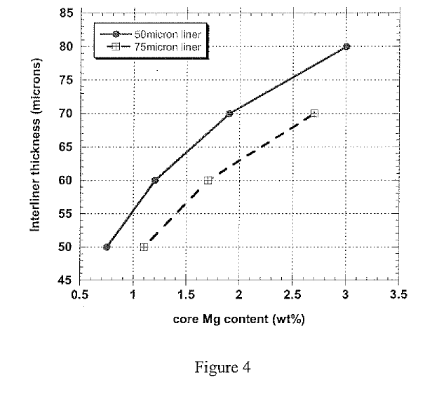

There can be several types of final products manufactured from the above mentioned process. One embodiment is braze sheet for tubestock, which will typically have a thickness ranging from about 150 to about 400 microns and produced in an H2X or H1X temper. The braze sheet would be constructed using a predetermined set of alloys and relative layer thicknesses to achieve the desired combination of formability, braze-ability, post-braze strength and corrosion resistance. Another embodiment of the present invention is for the manufacture of a heavier gauge product, such as for a radiator side support or a stiffener plate. The higher gauge product can utilize a different set of alloys and would generally be fabricated with a different relative layer thicknesses to optimize the product's attributes. One of the design considerations of a braze sheet is the diffusion distance of the Mg from the core layer towards the surfaces of the product during the fabrication in the mill and during the brazing cycle. As an example FIG. 4 shows the calculated thickness of the interliner needed to keep the average amount of Mg below 0.05 wt. % in the braze liner for a representative braze cycle for different core Mg contents. The example assumed an O-temper braze sheet of nominal 1 mm thickness having a range of about 0.8 to about 1.2 mm. Two different braze liner thicknesses were considered. Another consideration is the melting point (as reflected by the alloy solidus temperature) of the various layers since only the braze liners should melt during the braze cycle.

One of the final products of the present invention is tubestock. Tubestock is so thin that the high-Mg core alloy needs to be relatively thin and positioned near the mid-thickness of the tubestock. For example, radiator tubestocks are clad on the outside with a 4000 series filler alloy and to provide sufficient filler metal at the desired gauge, the clad ratio for the 4000 series liner will be in the range of about 10 to about 20% of the total thickness. The remaining 80 to 90% of the thickness would be a high Mg core and an interliner on one or both sides of the core and possibly a water side liner on the surface opposite the braze liner. One embodiment of the tubestock includes interliners and possibly a water-side liner that are Mg-free to promote good brazing especially in a folded tube configuration. For example, the first interliner situated between the filler metal and the core can be a 3000 series alloy with a composition comprising Mg up to about 0.15 wt. %, Mn up to about 1.8 wt. %, Si up to 1.2 wt. %, Cu up to 0.9 wt. %, Zn up to 2.0 wt. %, Fe up to 0.7 wt. %, and Ti for corrosion resistance up to 0.20 wt. %. The second interliner on the opposite side of the core is considered the water-side liner if there is no other layer bonded to its surface opposite the core since it will constitute the interior surface of the tube. In this case the second interliner can be a Zn-bearing alloy comprising Mn up to about 1.8 wt. % for additional strength, Si up to about 1.2 wt. %, Cu up to about 0.9 wt. %, Mg up to about 0.15 wt. %, Ti for corrosion resistance up to about 0.20 wt. %, Fe up to about 0.7 wt. %, and Zn up to about 6.0 wt. %. The core can be a 5000 series alloy with a Mg level up to approximately 3 wt. % and can contain Mn and or Cr for added strength, Si to provide the potential for age-hardening by Mg₂Si precipitation after brazing, and up to about 0.2 wt. % Ti can be added for corrosion protection. The thickness of each of the two inter layer materials in the final product can be approximately 40 microns or thicker, preferably 50 microns or thicker. However, it need only be as thick as thick as necessary to assure that the amount of Mg that diffuses from the core to the filler metal will be limited and not interfere with CAB brazing.

The interliner alloys can be 1000-series, 3000-series, 7000-series or 8000-series alloys to provide the diffusion barrier function and corrosion resistance functions required for the final product.

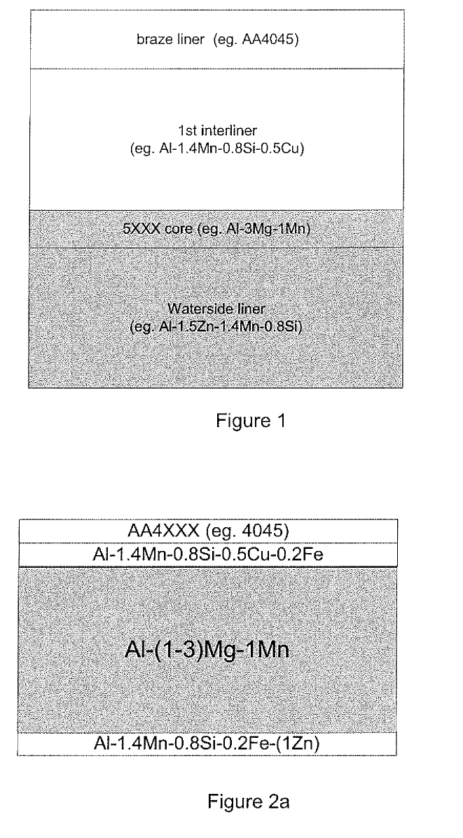

FIG. 1 illustrates one embodiment of the present invention being a high strength, 4-layer tubestock having a thickness between about 150 microns to 400 microns. Another embodiment of the present invention can include a 5-layer structure which the second interlayer embodiment of the present invention can include a 5-layer structure which the second inter layer (indicated as the water-side liner in FIG. 1) comprising two layers instead of one layer. A 3000 series alloy layer can be adjacent to the core similar in composition to the first layer interlayer and the second layer (e.g., a water-side liner) being a Zn-bearing alloy of the type described above. For the case of folded tube applications where the inside surface of the tube becomes part of a braze joint, then the second interliner and water-side liners would be essentially Mg-free. For welded tube applications, those layers could contain intentional Mg additions up to 1.0 wt. %. The thicknesses of the layers based on a percentage of the total thickness contemplated for the 4-layer structure shown in FIG. 1 can be a braze liner between about 15 to about 20%, first interlayer between about 30 to about 40%, core between about 10 to 25%, and waterside liner between about 30 to about 40%.

The core layer illustrated in FIG. 1 can comprise between about 0.5 wt. % and about 3.0 wt. % Mg, up to about 1.5 wt. % Mn, up to about 0.8 wt. % Cu, up to about 0.7 wt. % Si, up to about 0.7 wt. % Fe, up to about 0.15 wt. % Zr, up to about 0.25 wt. % Cr, up to about 0.2 wt. % Ti, and up to about 0.25 wt. % Zn. Another embodiment of the core layer can comprise Si between, about 0.20 to about 0.70 wt. % Si. Another embodiment of the core layer can comprise Mn up to about 1.8 wt. %.

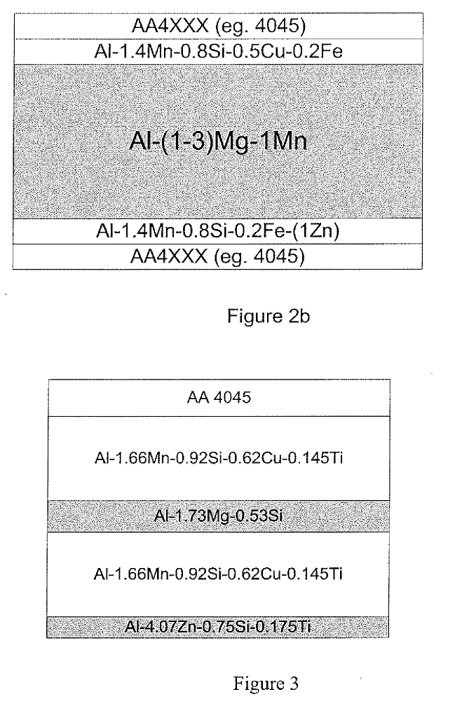

FIGS. 2A & 2B illustrate schematically another of the final products of the present invention, namely a braze sheet for high strength side support or tank material being approximately 1 mm to 4 mm in thickness, which is considered a heavy gauge. The relative thickness of the interlayers to the core alloy (in comparison to the ratios required in the tubestock products) can be reduced while still maintaining the required level of effective Mg diffusion barrier to assure excellent brazing performance. The interlayers are more typically 5% to 20% of the final product thickness or approximately 50 to 300 microns thick. The thickness of the interlayers allows for increasing the Mg content of the core layer, therefore, further increasing the post-braze strength. The thicknesses of the layers based on a percentage of the total thickness contemplated for the 4-layer structure shown in FIG. 2a can be a braze liner between about 5 to about 15 %, two (2) interlayers each between about 5 to about 20%, and a core between about 70 to 80%. The thicknesses of the layers based on a percentage of the total thickness contemplated for the 5-layer structure shown in FIG. 2b can be two (2) braze liners each between about 5 to about 10%, two (2) interlayers each between about 5 to about 20%, and a core between about 65 to 75%.

In FIG. 2a the core alloy is a 5000 series alloy with up to about 3 wt. % Mg. The Mg level can be adjusted to accommodate the anticipated maximum temperature that will be experienced during the braze cycle. For example, if the anticipated maximum braze temperature is 610° C. then the Mg level in the core should be limited to approximately 2.6 wt. % to avoid partial melting of the core during brazing. The interlayer materials can be 3000 series alloys with Mn up to about 1.8 wt. %, Si up to about 1.2 wt. % for strength, Cu up to about 1 wt. % can be present in either or both interliners for strength, Ti up to about 0.20 wt. % can be present in either or both interlayers for corrosion resistance, and Zn up to about 6.0 wt. % can be present in either or both interlayers for adjusting the through thickness corrosion potentials. A braze liner on one surface provides the filler metal needed to join to the fin, header or other components of the heat exchanger. Alternatively, the interliners could be 1000-series or 7000-series alloys selected to provide the desired Mg-diffusion barrier and corrosion resistance attributes to the final product.

FIG. 2b illustrates braze liners on both outer surfaces of the interlayers for instances where filler metal is needed at both surfaces. The elemental contents of the various layers are similar to those described for the one-side clad material except that in this case the second interliner necessarily would be essentially Mg-free.

### EXAMPLE 1

Testing was performed on a laboratory fabricated 5-layer braze sheeting having a core alloy of Al-1.73 Mg-0.53 Si bonded on both surfaces with interlayers of Al-1.66 Mn-0.92 Si-0.62 Cu-0.14 Ti via a hot mill process. The other surface of the first interlayer was clad with a braze liner of AA4045. The other surface of the second interliner was clad with a water-side liner of Al-4.07 Zn-0.75 Si-0.17 Ti. FIG. 3 illustrates schematically the general aspects of the structure of the as-produced sheet having approximate layer thicknesses in terms of percentage relative to the total sheet thinkness comprising a brazing layer (11-15%), two (2) interlayers (33-35% each interlayer), a core (10-15%), and a waterside liner (5-9%). The braze sheet was processed to H24 tubestocks having 200 microns and 150 microns final thickness. The post-braze strength of these two materials after different post-braze histories are reported in Tables 1-3. The age-hardening response of the materials is evident in these results as the 14 day at room temperature and the 30 day at 90° C. tensile properties are notably higher than the properties Immediately after brazing. These samples show significant increases in strength over a typical three layer 3000 series tubestock material which has a post-braze Ultimate Tensile Strength (UTS) of approximately 140-150 MPa, Yield Strength (YS) 45-55 MPa and does not exhibit any measurable post-braze age-hardening response.

TABLE 1
Post-braze tensile properties (immediately after brazing

| Gauge of material | UTS | YS | el |
|---|---|---|---|
| 200 microns | 182 MPa | 68.6 MPa | 13.2% |
| 150 microns | 186 MPa | 75.4 MPa | 11.8% |

TABLE 2
Post-braze tensile properties (after 14 days at room temperature)

| Gauge of material | UTS | YS | el |
|---|---|---|---|
| 200 microns | 200 MPa | 84.5 MPa | 12.8% |
| 150 microns | 203 MPa | 89.5 MPa | 10.8% |

TABLE 3
Post-braze tensile properties (after 30 days at 90 C.)

| Gauge of material | UTS | YS | el |
|---|---|---|---|
| 200 microns | 234 MPa | 121.4 MPa | 12.9% |
| 150 microns | 235 MPa | 126.9 MPa | 10.4% |

Brazeability of this multi-layer tubestock material, as judged by simple brazing tests including brazing bare fin to the tubestock in a laboratory braze furnace, was very good.

### EXAMPLE 2

Testing was performed on laboratory fabricated O-temper 1 mm gauge 4-layer composite materials. This material was composed of nominally 6% braze liner AA4045, a first interliner nominally 120 microns thick of Alloy I/L 1, nominally 710 micron thick core layer of alloys Cl, and a second interliner, nominally 117 microns thick of Alloy I/L 2. The alloy compositions are outlined below.

| Alloy | Si | Fe | Cu | Mn | Mg | Cr | Zn | Ti |
|---|---|---|---|---|---|---|---|---|
| I/L 1 | 0.77 | 0.5 | 0.54 | 1.25 | 0.01 | 0 | 0.02 | 0.13 |
| C1 | 0.07 | 0.24 | 0 | 0.03 | 2.44 | 0.11 | 0 | 0.14 |
| I/L 2 | 0.28 | 0.52 | 0.11 | 1.1 | 0.03 | 0.02 | 1.45 | 0.02 |

The post-braze tensile strength of this material was measured as: 187 MPa UTS, 73 MPa YS, 20% elongation after 7 days at room temperature. Due to the low Si content of the core in this material the age hardening response is low and properties did not change significantly at room temperature over time.

In brazing evaluation for this material, the braze-ability was generally judged as very good. The one exception to that is where the sheared or cut edge of the multi-layer material is required to braze against another sheet. In this case the magnesium in the high-Mg core has a largely unimpeded ability to interfere with the action of the flux and in those instances the braze joint was not as continuous or as large as desired.

The layer thicknesses shown in FIGS. 1-3 are examples and are not intended to limit the claimed invention.

While various embodiments of the present invention have been described in detail, it is apparent that modifications and adaptations of those embodiments may occur to those skilled in the art. However, it is to be expressly understood that such modifications and adaptations are within the spirit and scope of the present invention.

We claim:

1. A multi-layer aluminum brazing sheet comprising:
a first AA3000 series alloy interlayer comprising up to about 0.15 wt. % Mg, up to about 1.8 wt. % Mn, up to about 1.2 wt. % Si, up to about 0.9 wt. % Cu, up to about 0.20 wt. % Ti, up to about 2.0 wt. % Zn and up to about 0.7 wt. % Fe;
a core layer being positioned adjacent the first interlayer, the core layer comprising between about 1.0 wt. % and about 3.0 wt. % Mg, up to about 1.5 wt. % Mn, up to about 0.8 wt. % Cu, up to about 0.7 wt. % Si, up to about 0.7 wt. % Fe, up to about 0.15 wt. % Zr, up to about 0.25 wt. % Cr, up to about 0.2 wt. % Ti, and up to about 0.25 wt. % Zn; and
a second AA3000 series alloy interlayer adjacent to the core comprising up to about 0.15 wt. % Mg, up to about 6.0 wt. % Zn, up to about 1.8 wt. % Mn, up to about 1.2 wt. % Si, up to about 0.9 wt. % Cu, up to about 0.20 wt. % Ti, and up to about 0.7 wt. % Fe; and
an AA4000 series alloy braze liner being positioned adjacent the first interlayer such that the first interlayer is disposed between the AA4000 series alloy braze liner and the core layer.

2. The multi-layer aluminum brazing sheet according to claim 1 wherein the core layer comprises about 0.20 to about 0.70 wt. % Si.

3. The multi-layer aluminum brazing sheet according to claim 1, wherein the multi-alloy aluminum brazing sheet is fabricated by a simultaneous multi-alloy casting process.

4. The multi-layer aluminum brazing sheet according to claim 1, wherein the multi-alloy aluminum brazing sheet is fabricated by a unidirectional solidification of casting process.

5. The multi-layer aluminum brazing sheet according to claim 1, wherein the multi-alloy aluminum brazing sheet is fabricated by a fusion casting process.

6. The multi-layer aluminum brazing sheet according to claim 1 wherein the multi-layer aluminum brazing sheet is formed into a tubestock having a thickness of between about 150 microns to about 400 microns.

7. The multi-layer aluminum brazing sheet according to claim 1 wherein the first interliner comprises a thickness of at least 40 microns.

8. The multi-layer aluminum brazing sheet according to claim 1 wherein the second interliner comprises a thickness of at least 40 microns.

9. The multi-layer aluminum brazing sheet according to claim 1 wherein the core layer being selected from the group consisting of an AA3000 series and an AA5000 series aluminum alloys.

10. The multi-layer aluminum brazing sheet according to claim 1 further comprising an outer layer being positioned adjacent the second interlayer and being selected from the group consisting of an AA1000 series, an AA3000 series , an AA4000 series, and an AA7000 series aluminum alloy.

11. The multi-layer aluminum brazing sheet according to claim 1 wherein the AA4000 series alloy braze liner comprises up to about 2.5 wt. % Zn.

12. The multi-layer aluminum brazing sheet according to claim 1 wherein the core comprises between about 1.1 wt. % and about 3.0 wt. % Mg.

13. The multi-layer aluminum brazing sheet according to claim 1 wherein the core comprises between about 1.5 wt. % and about 3.0 wt. % Mg.

14. The multi-layer aluminum brazing sheet according to claim 1 wherein the core comprises between about 2.0 wt. % and about 3.0 wt. % Mg.

15. The multi-layer aluminum brazing sheet according to claim 1 wherein the core comprises between about 2.5 wt. % and about 3.0 wt. % Mg.

16. A multi-layer aluminum brazing sheet product comprising:
a first interlayer being selected from a group consisting of an AA1000-series, an AA3000-series, an AA7000-series, and an AA8000-series aluminum alloy;
a core layer disposed between the first and the second interlayers, the core layer comprising between about 1.0 to about 3.0 wt. % Mg, up to about 1.8 wt. % Mn, up to about 0.8 wt. % Cu, up to about 0.7 wt. % Si, up to about 0.7 wt. % Fe, up to about 0.25 wt. % Zn, up to about 0.15 wt. % Zr, up to about 0.25 wt. % Cr, up to about 0.2 wt. % Ti,
a second interliner being selected from a group consisting of an AA1000-series, an AA3000-series, an AA7000-series, and an AA8000-series aluminum alloy; and
an AA4000 series aluminum alloy braze liner being positioned adjacent to the first interliner the AA4000 series alloy braze liner comprising up to about 2.5 wt. % Zn.

17. The multi-layer aluminum brazing sheet product according to claim 16 further comprising wherein the core layer comprises about 0.20 to about 0.70 wt. % Si.

18. The multi-layer aluminum brazing sheet product according to claim 16, wherein the multi-alloy aluminum brazing sheet is fabricated by a simultaneous multi-alloy casting process.

19. The multi-layer aluminum brazing sheet product according to claim 16, wherein the multi-alloy aluminum brazing sheet is fabricated by a unidirectional solidification of casting process.

20. The multi-layer aluminum brazing sheet product according to claim 16, wherein the multi-alloy aluminum brazing sheet is fabricated by a fusion casting process.

21. The multi-layer aluminum brazing sheet product according to claim 16 wherein the multi-layer aluminum brazing sheet product has a thickness of between about 150 to about 400 microns.

22. The multi-layer aluminum brazing sheet product according to claim 16 wherein the first interliner comprises a thickness of at least 40 microns and the second interliner comprises a thickness of at least 40 microns.

23. The multi-layer aluminum brazing sheet product according to claim 16 wherein the core alloy is selected from the group consisting of an AA3000 series and an AA5000 series aluminum alloys.

24. The multi-layer aluminum brazing sheet product according to claim 16 further comprising an outer layer being positioned adjacent the second interlayer and being selected from the group consisting of an AA 1000 series, an AA3000 series, an AA4000 series, and an AA7000 series aluminum alloy.

25. The multi-layer aluminum brazing sheet according to clam 16 wherein the core comprises between about 1.1 wt. % and about 3.0 wt. % Mg.

26. The multi-layer aluminum brazing sheet according to clam 16 wherein the core comprises between about 1.5 wt. % and about 3.0 wt. % Mg.

27. The multi-layer aluminum brazing sheet according to clam 16 wherein the core comprises between about 2.0 wt. % and about 3.0 wt. % Mg.

28. The multi-layer aluminum brazing sheet according to clam 16 wherein the core comprises between about 2.5 wt. % and about 3.0 wt. % Mg.

29. The multi-layer aluminum brazing sheet product according to claim 21 wherein the multi-layer aluminum brazing sheet product is an H2X or H1X temper.

30. The multi-layer aluminum brazing sheet product according to claim 16 wherein the multi-layer aluminum brazing sheet product has a thickness of between about 0.8 to about 1.2 mm

31. The multi-layer aluminum brazing sheet product according to claim 30 wherein the multi-layer aluminum brazing sheet product is an O temper.

32. The multi-layer aluminum brazing sheet product according to claim 16 wherein the core layer has a thickness being about 10 to about 25% of a thickness of the sheet.

33. The multi-layer aluminum brazing sheet product according to claim 1 wherein the core layer has a thickness being about 10 to about 25% of a thickness of the sheet.

34. The multi-layer aluminum brazing sheet of claim 1, wherein the fabrication process of the multi-layer aluminum brazing sheet contains a step in which a multi-alloy layered composite ingot comprising a high-Mg core layer is cast, and whereby the multi-layer aluminum brazing sheet is suitable for Controlled Atmosphere Brazing.

35. The multi-layer aluminum brazing sheet product of claim 16, wherein the multi-layer aluminum brazing sheet product is partially fabricated via a multi-alloy casting process, and whereby the multi-layer aluminum brazing sheet product is suitable for Controlled Atmosphere Brazing.
